(19) United States
(12) Patent Application Publication
(10) Pub. No.: US 2002/0000442 A1
(43) Pub. Date: Jan. 3, 2002

(54) Nestable, dual-ovenable, thin-walled cooking pan with integral handles and enhanced strength and rigidity

(76) Inventors: John R. Howard, Northwoods, IL (US); Charles E. Nichols, Plainfield, IL (US); Mohamad Ali Jamnia, Chicago, IL (US); Robert Emmet Walter, Bolingbrook, IL (US)

Correspondence Address: Thomas R. Trempus, Alcoa Technical Center, 100 Technical Drive, Alcoa Center, PA, 15069-0001, US

(21) Appl. No.: 09/771,076

(22) Filed: Jan. 29, 2001

Related U.S. Application Data
(63) Continuation-in-part of application No. 09/350,450, filed on Jul. 9, 1999, now abandoned.
(60) Provisional application No. 60/092,187, filed on Jul. 9, 1998.

(51) Int. Cl. A47J 27/00; A47J 36/00; A47J 37/01

(52) U.S. Cl. 220/573.1

(57) ABSTRACT

A nestable, dual-ovenable cooking pan (10) made of thin, thermoformed plastic sheet material has an interlocking beam and skin structure including a peripheral frame (24) in its floor (12) and vertical horizontal ribs (28, 30) in its walls (14, 16). This structure cooperates with integral handles (32) in a top flange (20) to enhance strength and rigidity. The handles have uniform or non-uniform undulations (34, 36) which, in addition to providing rigidity, increase the effective thickness of the handles and allow the pan to be comfortably picked up and carried when hot. The handles cool relatively quickly. The undulations give the handles a purchase and feel similar to those of thicker handles of ceramic permanent cookware. The plastic sheet material is preferably nucleated CPET.

### RELATED APPLICATION

This application discloses and claims subject matter which was disclosed in copending patent application Ser. No. 09/350,450 filed Jul. 9, 1999, which discloses and claims subject matter disclosed in provisional patent application Ser. No. 60/092,187, filed Jul. 9, 1998. Both earlier applications are titled Dual-ovenable Thin-walled Cooking Pan with Enhanced Strength and Rigidity.

### TECHNICAL FIELD

This invention pertains to the field of cooking pans.

### BACKGROUND ART

Permanent cookware which is dual-ovenable, i.e., which may be used in either a microwave oven or a conventional oven, has been commercially available for many years. Such cookware may be made of various materials including ceramic and glass. Examples are Corningware® and Pyrex®, both of which are sold by Corning/Revere. Corningware® cookware is made of a glass-ceramic material, while Pyrex® cookware is made of tempered glass. Casseroles, pans, bowls, and dishes of these excellent products are listed and depicted in the Corning/Revere 1998-99 Replacement and Accessory Catalog at pages 7-12. Some of this cookware has, at the tops of opposite walls, integral horizontal handles for picking up and carrying the cookware. When the cookware is hot, the user must wear gloves. Although generally sturdy and durable, the cookware may shatter when dropped on a hard surface.

Disposable dual-ovenable cookware is also well known. Such products may have ribs to provide increased rigidity and are usually made of thin plastic sheet material. For example, Michaud et al. U.S. Pat. No. 4,742,934 discloses a dual ovenable food tray thermoformed from crystallized polyethylene terephthalate (CPET) sheet material and having vertical ribs. Nissel U.S. Pat. No. 5,318,811 discloses a similar, ribless tray and discusses the relationship between the nucleating agent, crystallization, and rigidity at elevated temperatures.

Many trays, pans, plates, and the like which are not dual-ovenable also have strengthening ribs of various configurations in various locations. Hundley U.S. Pat. No. 5,381,901 discloses a food tray shaped like a stadium with “seats” in the side walls and end walls, these seats are separated by vertical “aisles”. Linderman U.S. Pat. No. 2,125,793 and Andersson U.S. Pat. No. 3,938,727 disclose paper plates having alternating ridges and valleys in the flange. Conti U.S. Pat. Des. No. 350,669 discloses a roasting pan having indentations in its flange. Tucker et al. U.S. Pat. Des. No. 390,109 discloses a lid formed of plastic sheet material which has opposed gripping members with alternating ridges and valleys. Bach U.S. Pat. Des. No. 144,477 and Gecchelin U.S. Pat. Des. No. 319,165 disclose thick-walled trays having handles with irregular gripping surfaces. Rideout U.S. Pat. No. 2,262,204 discloses a dishpan having a rim with opposed corrugated handle portions

Permanent dual-ovenable cookware and disposable dual-ovenable cookware have their respective advantages and disadvantages. Advantages of the former include reusability, durability, sturdiness, and structural rigidity at all operating temperatures Advantages of the latter include low unit cost, nestability (and hence saving cabinet space), light weight, and convenience (due to the elimination of the need to wash and dry a bulky container). Another advantage of disposable dual-ovenable cookware is that it is well suited for cooking and bringing food to a social gathering remote from the user's home, because there is no need for retrieving, cleaning, bringing home, or otherwise dealing with the cookware after the conclusion of the social function. This last-mentioned advantage has become more important in recent years, because of the increased popularity of cooking food and bringing it to social functions.

Acceptance and use of disposable dual-ovenable cookware has been limited by several factors. A primary factor has been lack of rigidity and strength, particularly when the cookware is loaded with a hot food product. Another factor has been relatively high unit cost, since relatively thick walls have been required in order to provide necessary rigidity and strength. Another factor has been the lack of an option to re-use the cookware, which, even though designed to be disposable, is potentially re-usable if previous use has not been too demanding.

### SUMMARY OF THE INVENTION

An object of the invention is to provide a nestable, dual-ovenable cooking pan made of thin, thermoformed plastic sheet material, which pan, while retaining the advantages of known disposable dual-ovenable cookware, also has some of the advantages of permanent cookware.

Another object of the invention is to provide a nestable, dual-ovenable cooking pan whose strength and rigidity are enhanced, particularly at elevated temperatures, by its “interlocking beam and skin” structure.

Another object of the invention is to provide a nestable, dual-ovenable cooking pan with strong integral handles which cooperate with the interlocking beam and skin structure to allow the pan to be picked up and carried by the handles, even at elevated temperatures.

Another object of the invention is to provide a nestable, dual-ovenable cooking pan which may be comfortably picked up and carried at elevated temperatures with bare hands, without gloves.

Still another object of the invention is to provide a nestable, dual-ovenable cooking pan whose handles cool relatively quickly.

Yet another object of the invention is to accomplish the foregoing with a pan whose unit cost is sufficiently low that the pan is disposable.

These and other objectives of the invention are achieved by a pan having a bottom, walls extending upwardly from the bottom at an obtuse angle, and a continuous flange extending outwardly at the top of the walls. In the flange, at opposite ends of the pan, are two integral handles. Each handle has a gripping area comprising undulations, which may be uniform and parallel, but are not required to be uniform or parallel. The undulations give the handles a purchase and feel similar to those of thicker handles of ceramic permanent cookware. The wavelength of the undulations (i.e., the distance between adjacent ridges or adjacent valleys) should be sufficiently short, and their amplitude (i.e., the distance between the uppermost and lowermost surfaces of sheet material) sufficiently great, that the area of contact between the sheet material of the handle and the fingers of a user grasping the handles is limited, due to the fact that the radius of curvature of the undulations is substantially less than the radius of curvature of the user's fingers. Also, the handles cool relatively quickly.

Vertical and horizontal ribs in the walls of the pan and a peripheral frame in the bottom of the pan provide the interlocking beam and skin construction. The ribs, frame, and undulations in the handle cooperate to give strength and rigidity to the pan, even at elevated temperatures. Each vertical rib preferably has a width which is at least 10 times the thickness of the sheet material, and each vertical rib is spaced from adjoining vertical ribs by a distance which is less than 40 percent of that width.

The plastic sheet material should be resistant to temperatures of 400° F., and preferably is nucleated CPET whose crystallinity is in the range of 20 percent to 40 percent. Its thickness should be in the range of about 0.020 inch to about 0.050 inch, and preferably is in the range of about 0.030 inch to about 0.045 inch.

### BRIEF DESCRIPTION OF THE DRAWINGS

FIG. 1 is a plan view of a rectangular pan.

FIG. 2 is a section of FIG. 1 taken at 2-2. The left half of FIG. 2 is in section, while the right half of FIG. 2 is an elevation.

FIG. 3 is a section of FIG. 1 taken at 3-3 and showing a handle.

FIG. 4 is a fragmentary section of FIG. 2 taken at 4-4.

FIG. 5 is a plan view of a circular pan.

FIG. 6 is a section of FIG. 5 taken at 6-6.

FIG. 7 is an exploded perspective view of the rectangular pan shown in FIGS. 1-4 and a domed lid.

FIG. 8 is a graph comparing the cooldown rate of the handles of a pan according to the present invention with cooldown rates of handles of pans made of several other materials.

FIG. 9 is a graph comparing the maximum temperature permitting comfortable transport for a pan according to the present invention with the corresponding temperatures for pans made of the other materials.

FIG. 10 is a graph comparing the cooling time required for comfortable transport for a pan according to the present invention with the corresponding times for pans made of the other materials.

FIG. 11 is a schematic cross-section along the length of a rectangular pan showing where dimensions of the pans referred to in FIGS. 8-10 were measured.

FIG. 12 is similar to FIG. 11, with the section taken along the width of the rectangular pan.

FIG. 13 is a fragmentary plan view of a variation of the pan shown in FIG. 1, which variation has a handle with undulations in a different pattern.

FIG. 14 is a section of FIG. 13 taken at 14-14.

FIG. 15 is similar to FIG. 13 and shows another variation.

FIG. 16 is a section of FIG. 15 taken at 16-16.

FIG. 17 is similar to FIG. 13 and shows another variation.

FIG. 18 is a section of FIG. 17 taken at 18-18.

FIG. 19 is similar to FIG. 13 and shows another variation.

FIG. 20 is a section of FIG. 19 taken at 20-20.

The drawings show the pans approximately to scale, except for cross-section thickness. Approximate actual dimensions of the rectangular pan are 15.4 in. by 11 0 in. by 2 5 in. (height), with a top opening of 12.8 in. by 9.1 in. Approximate actual dimensions of the circular pan are 10.8 in by 9.6 in. by 3.0 in. (height), with a top opening of 8.2 in. diameter.

### DESCRIPTION OF THE PREFERRED EMBODIMENT

The following terms are used throughout this application in accordance with these definitions, unless a different interpretation is required by the context. The term “pan” refers to cookware containers of various configurations and sizes, including pans, trays, casseroles, bowls, dishes, pots, and roasters. Directional terms such as “horizontal” and “vertical” refer to the orientation of the pan as it would rest on a flat horizontal surface. The term “torsional rigidity” refers to resistance to rotational twisting of a loaded pan about its horizontal longitudinal axis, as would occur if the user picks up the pan by only one corner, or by two adjacent corners. The terms “bending rigidity” and “stiffness” refer to resistance to deflection of a loaded pan at its horizontal transverse axis, as occurs when the user picks up the pan by both handles. “Dimensional stability” refers to resistance to deformation (mainly shrinkage due to crystallization) resulting from heating to elevated temperatures. The “effective thickness” of a handle of a pan is the vertical distance between the topmost and bottommost horizontal surfaces of the handle which are grasped by a user picking up the pan. A handle is said to have “undulations” if, as viewed in any vertical cross-section, it has uniform or non-uniform undulations of any shape, including sinusoidal, ogee, triangular, square, or trapezoidal. The term “transport” refers to picking up, holding, moving, and/or carrying a pan.

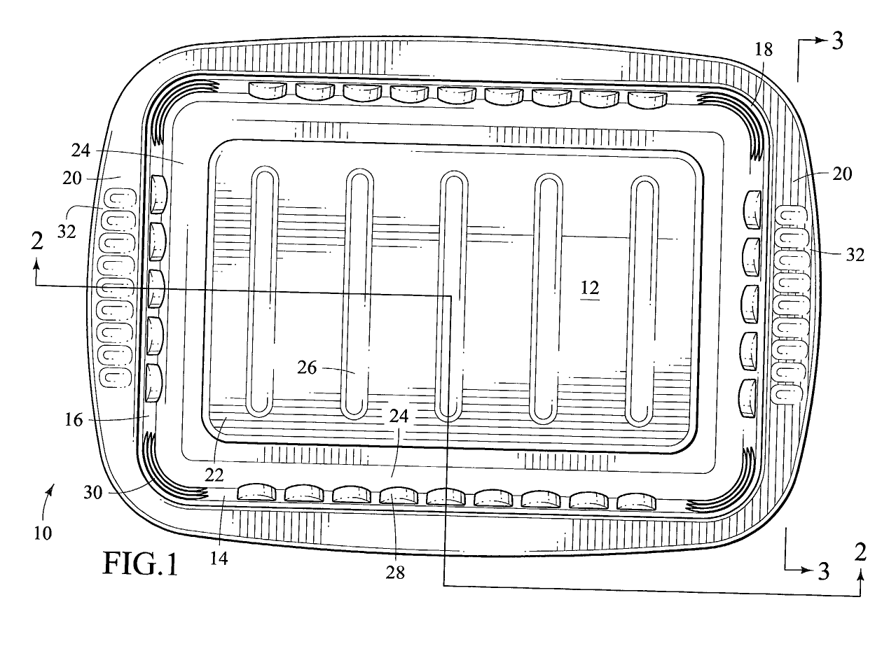

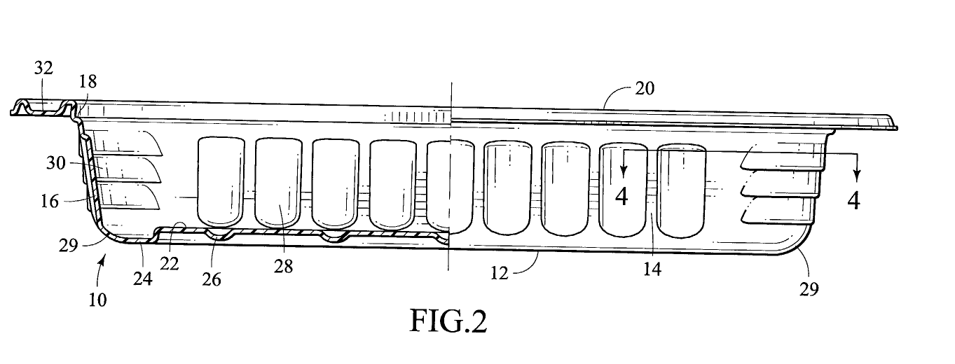

As shown in FIGS. 1 and 2, rectangular cooking pan 10 has horizontal bottom or floor 12, with side walls 14 and end walls 16 extending upwardly from the periphery of bottom 12 at an obtuse angle thereto. Walls 14, 16 terminate in a step which defines annular groove 18 surrounded by horizontal rim or flange 20. Bottom 12 includes an upwardly formed central plateau 22 surrounded by downwardly projecting rails forming rectangular peripheral frame 24 approximately one inch wide. Frame 24 increases torsional and bending rigidity of the pan and permits stacking of filled pans having lids. Ribs 26 extend downward from plateau 22, terminating above the plane of the bottom surfaces of frame 24. In the horizontal direction, ribs 26 terminate about one-half inch from frame 24. Like frame 24, ribs 26 increase torsional and bending rigidity of the pan.

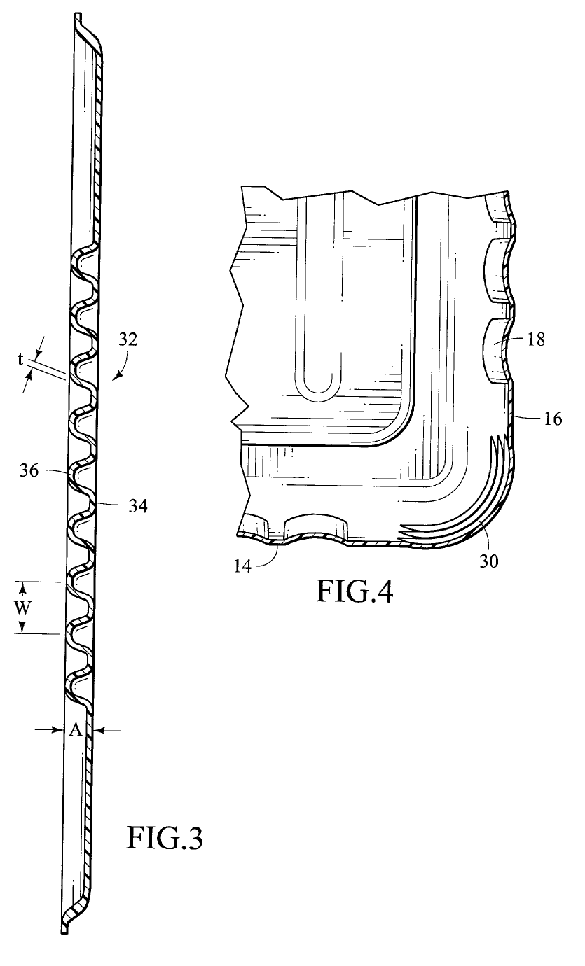

Integral handles 32 are formed in flange 20 at opposite ends of the pan, where they constitute the maximum horizontal dimension (length) of the pan. As best shown in FIG. 3, each handle 32 comprises undulations in the form of alternating ridges 34 and valleys 36. The undulations may be uniform and sinusoidal, as shown in FIG. 3, or may have another uniform or non-uniform configuration. The undulations may be parallel to each other or non-parallel. Preferably the undulations of each handle 32 have an amplitude A (i.e., the distance between the uppermost and lowermost surfaces of sheet material) which is greater than 3 times the thickness of the sheet material t, and have a wavelength W (i.e., the distance between adjacent ridges 34 or the distance between adjacent valleys 36) which is less than 20 times thickness t.

Amplitude A and wavelength W should be selected so as to limit the area of possible contact between the sheet material in the handle and the fingers of a typical user having small fingers. In FIG. 3, wavelength W is approximately 0.5 inches, which is the approximate width of a typical small finger, and amplitude A is approximately 0.25 inches. As a rule of thumb, figuratively speaking, such a “square” wave (i.e., a wave in which A is approximately equal to 0.5W) is a desirable configuration for the undulations. Amplitude A is sufficiently large, and wavelength W is sufficiently small, that the user's fingers supporting the handle, even if extended parallel to the undulations and lying in a valley (as viewed from beneath), tend to be tangent to the bottom surface of the undulations at lines parallel to the undulations, rather than in continuous area contact with that surface.

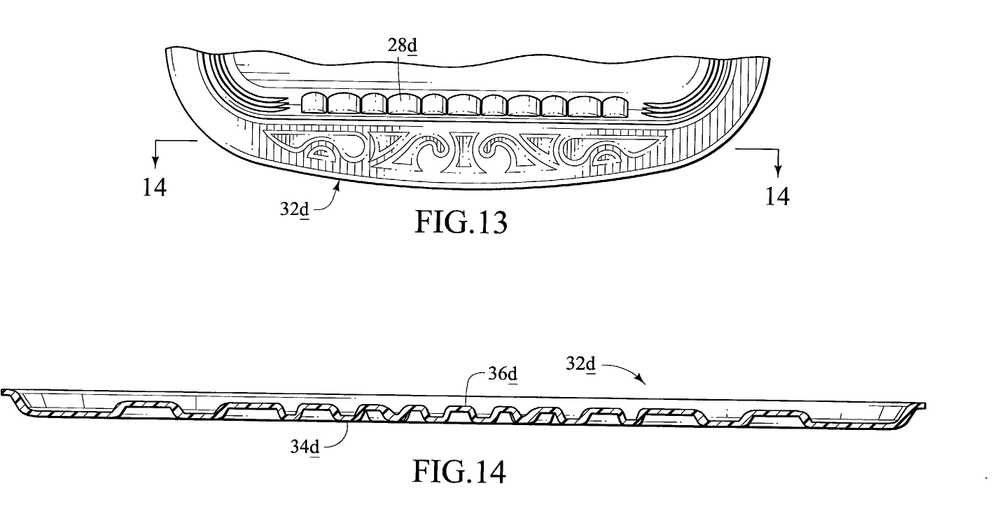

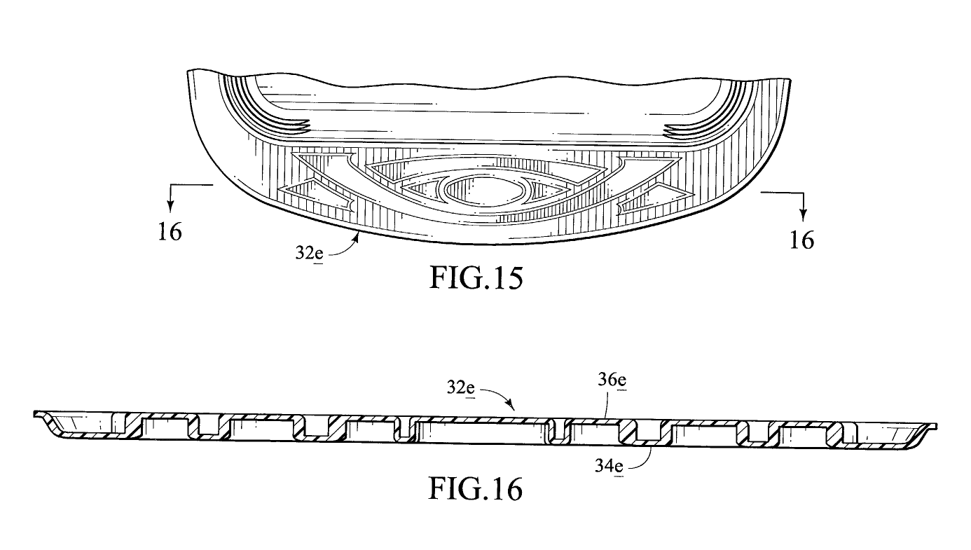

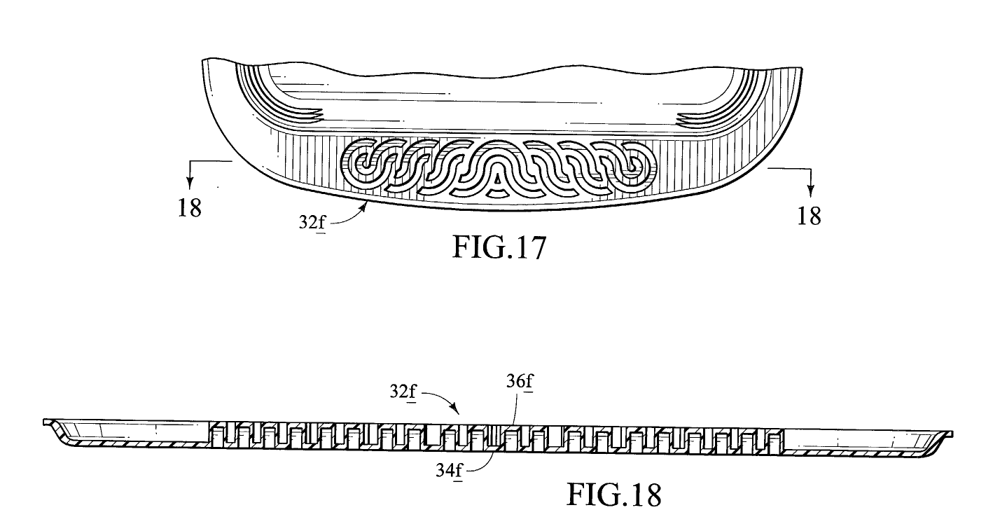

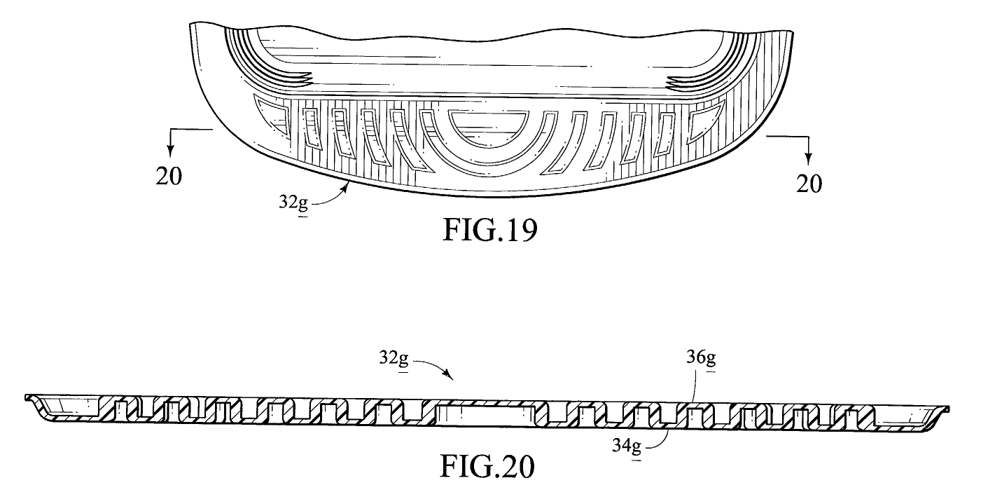

FIGS. 13-20 show examples of undulations which are not uniform or parallel. These undulations form decorative patterns. In FIGS. 13 and 14, handle 32d has undulations in the form of alternating ridges and valleys 34d and 36d. In FIGS. 15 and 16, handle 32e has undulations in the form of alternating ridges and valleys 34e and 36e. In FIGS. 17 and 18, handle 32f has undulations in the form of alternating ridges and valleys 34f and 36f. In FIGS. 19 and 20, handle 32g has undulations in the form of alternating ridges and valleys 34g and 36g.

Formed in walls 14, 16 are vertical ribs 28 which are relatively wide and are spaced relatively close together, as shown in FIGS. 1 and 2. Preferably vertical ribs 28 blend and interlock with radius 29 joining walls 14, 16 with frame 24 of bottom 12. To permit the easy removal of cooked food, vertical ribs 28 should have a gentle curvature as viewed in horizontal cross-section, for example a convex or lenticular shape. The vertical ribs may abut, as exemplified by vertical ribs 28d shown in FIG. 13.

Horizontal ribs 30 are also formed in walls 14, 16, at the corners of the pan. Horizontal ribs 30 extend around only a minor portion of the periphery of walls 14, 16. There are three horizontal ribs 30, which extend along the curved regions of walls 14, 16 in the corners. Horizontal ribs 30 do not extend along the flat regions of the walls, except immediately adjacent the curved regions.

Based on finite element analysis, we believe that making these horizontal ribs shorter or longer would lessen their efficacy in strengthening the pan. That is, the length of the horizontal ribs shown in FIGS. 1 and 2 (which, for example, are about 1.6 inches long in that particular rectangular tray) provide maximum torsional rigidity and bending rigidity. Extending the horizontal ribs along the flat regions of the walls would lessen their strengthening effect, and extending them along these flat regions until they form continuous ribs around the periphery of the tray walls would result in a tray weaker than a tray with no horizontal ribs at all. Thus, adding ribs to the walls of a tray of thin plastic sheet material, or extending such ribs that already exist, may actually weaken the tray. We believe that the reason for this apparently counterintuitive proposition lies in the mechanism by which the horizontal ribs do their job and in the immediate cause of the excessive deflection we are seeking to avoid. The horizontal ribs do their job by preventing the walls at the corners from opening or closing (i.e., changing from a 90° angle to an obtuse angle or an acute angle), and thus work in the same manner as shelf brackets, or inside corner braces added to a wood frame for a window screen. The immediate cause of the unacceptable deflection is warping of the walls in the regions of the walls approximately equidistant from the corners.

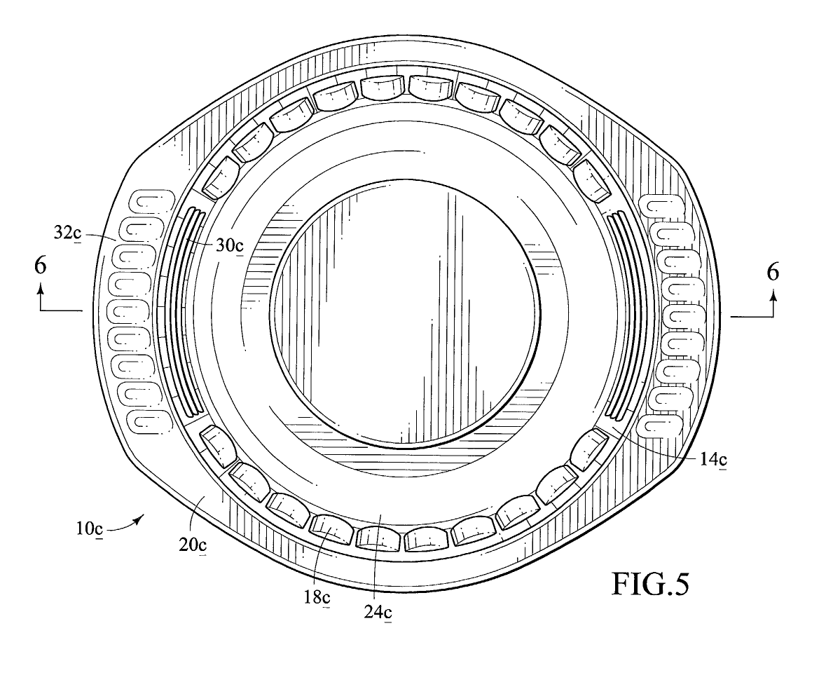

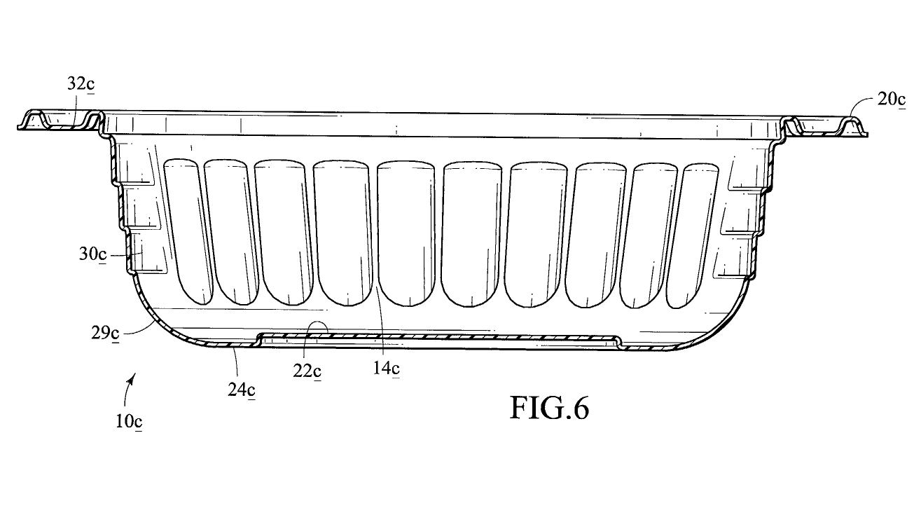

The pan according to the invention may have other configurations, such as a circular configuration, as shown in FIGS. 5 and 6, whose reference characters have the suffix “c” but otherwise are the same as those in FIGS. 1-4 for the corresponding features. Horizontal ribs 30c are located on walls 14c below handles 32c, however. As in the rectangular pan, vertical ribs 28c and horizontal ribs 30c cooperate to increase torsional and bending rigidity. The continuously curving walls of the circular pan provide good strength and rigidity. Horizontal ribs 30c resist the tendency of handles 32c to warp or “tip up” from a flat, horizontal orientation to a serpentine, vertical orientation, thereby preventing the regions of the walls equidistant from the handles from moving away from each other, or “sagging”.

Horizontal ribs in the walls are believed to be more important than vertical ribs in the walls, for increasing the strength and rigidity of the pan. As shown in FIGS. 15, 17, and 19, vertical ribs may be omitted.

The composition of the sheet material of pan 10 is selected so that the pan retains adequate strength and dimensional stability when heated to cooking temperatures in the range of 400° F., while having adequate impact strength at temperatures below 32° F. The preferred material is crystalline polyethylene terephthalate (CPET) of the type used for ovenable trays in which frozen food products are sold. Typically extruded sheets of amorphous PET (APET) which contain a nucleating agent are thermoformed to the desired configuration. The heating during thermoforming produces the desired crystallinity. Further crystallization occurs during cooking. The material may be in one color or a combination of various colors, and the flange or other parts of the pan may be embossed with a decorative pattern.

The crystallinity of the CPET in the pan according to the invention, before cooking, should be in the range of from about 20 percent to about 40 percent, and preferably in the range of about 25 percent to 35 percent. The higher the crystallinity, the better the strength and dimensional stability at temperatures in the range of 400° F., but the lower the impact strength at low temperatures, which may be a problem with containers for frozen or refrigerated food. The above-mentioned ranges of crystallinity are higher than the typical ranges for frozen food trays because the pan according to the invention will not be transported or handled extensively at low temperatures.

Pan 10 should be sufficiently economical and durable as to be either disposable or reusable, as desired by the user. To achieve these objectives the thickness of the sheet material should be in the range of about 0.020 to about 0.050 inch, and preferably in the range of about 0.030 to about 0.045 inch, as stated earlier.

In principle the torsional and bending rigidity described above is achieved with relatively thin sheet material because the sheet material is configured into a number of interlocking “beams” with “skin” stretched between them. These beams include frame 24, bottom ribs 26, vertical ribs 28, horizontal ribs 30, and flange 20, all of which have appreciable cross-sectional width and height. This configuration provides structural rigidity while permitting the pan to be made from a sheet of uniform thickness, thereby reducing the cost of producing the sheet material and the complexity and cost of thermoforming and die cutting it.

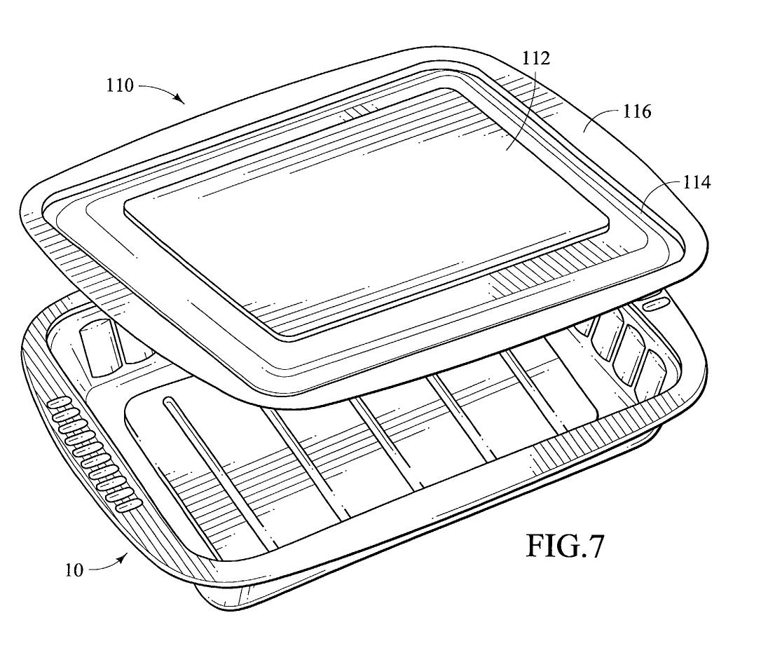

As shown in FIG. 7, snap lid 110 has central domed portion 112, downwardly projecting annular bead or tongue 114, and horizontal flange 116. When lid 110 is placed on pan 10, tongue 114 snaps into groove 18 and horizontal flanges 20 and 116 are generally in contact with each other. Lid 110 is made of a transparent plastic material which will withstand temperatures in the range of 250° F., but will not be used in a conventional oven. The domed portion of the lid may have lengthwise reinforcing ribs. The sides of the lid may have continuous horizontal reinforcing ribs similar to horizontal ribs 30 in pan 10.

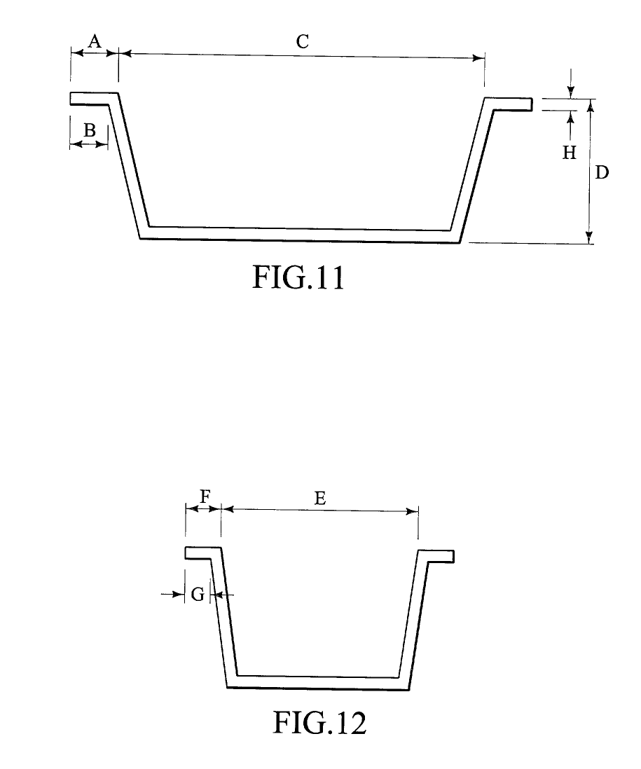

Cooldown characteristics of the pan according to the invention were evaluated in comparative tests. The tests compared the inventive pan to commercially available pans made of four other materials—glass (Pyrex®), ceramic (Corningware®), stainless steel, and aluminum foil (Reynolds® Redi-pan®). The dimensions and thicknesses of the pans, measured as shown in FIGS. 11 and 12, were as set forth in the following table, in inches:

| | | | | Stainless | Aluminum |
|---|---|---|---|---|---|
| | Glass | Ceramic | Invention | Steel | Foil |
| A | 13/16 | 13/16 | 1⅛ | 5/16 | ¼ |
| B | 9/16 | 11/16 | 1 1/16 | ¼ | 3/16 |
| C | 8 15/16 | 9 | 8 1/16 | 8 13/16 | 7⅞ |
| D | 2⅞ | 4 15/16 | 2⅞ | 2½ | 2⅛ |
| E | 4⅜ | 5 | 5 1/16 | 5 13/16 | 3⅞ |
| F | 15/16 | 3/16 | ⅝* | 5/16 | ¼ |
| G | 0 | 0 | 9/16 | ¼ | 3/16 |
| H | ¼ | 3/16 | ¼ | 3/64 | 1/32** |

*at widest spot (effective thickness)
**with 1/8 bead at periphery

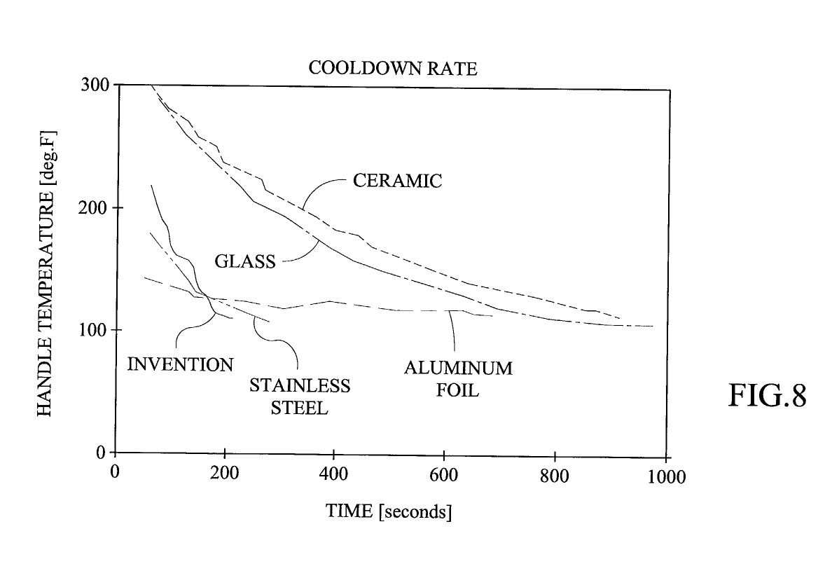

Each pan was filled with 2 lbs. of Bush's baked beans (the aluminum foil pan had 1.5 lbs.) and placed on a cookie sheet in a conventional oven preheated to 400° F. for at least 45 minutes. Type k thermocouples were attached to the bottom of the handles with Kapton tape prior to insertion in the oven. (If a thermocouple fell off during the test it was reattached after removal from the oven.) While the pans were in the oven, the peak temperature recorded was 383° F. Then the pans with the cookie sheet supporting them were removed from the oven and allowed to cool to room temperature. FIG. 8 shows a graph of the recorded temperatures on the handle bottom surfaces plotted against time after removal of the pans from the oven. Plotting of the data began one minute after removal from the oven, since the thermocouples re-attached after removal from the oven required some time to stabilize. As the pans were cooling, the same person tried periodically to lift and hold the pans by the handles (or flange) with bare hands. If they were too hot to hold for 10 seconds, they were put down and tried later.

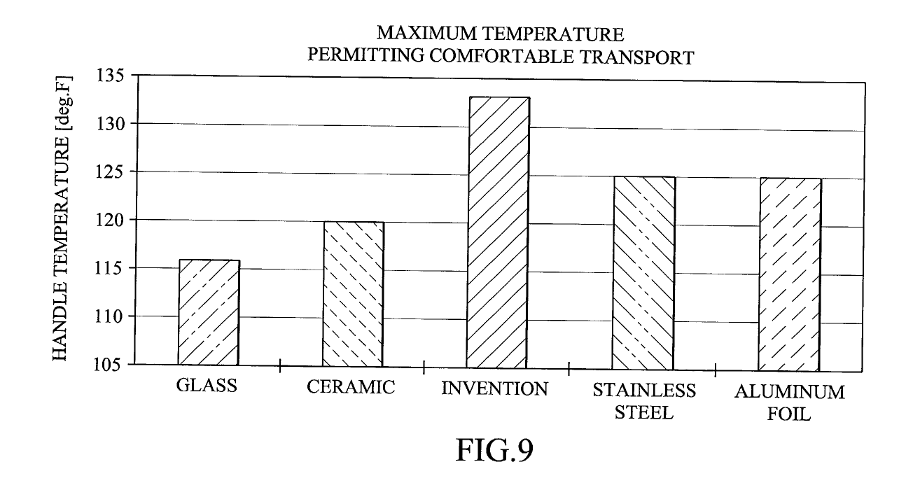

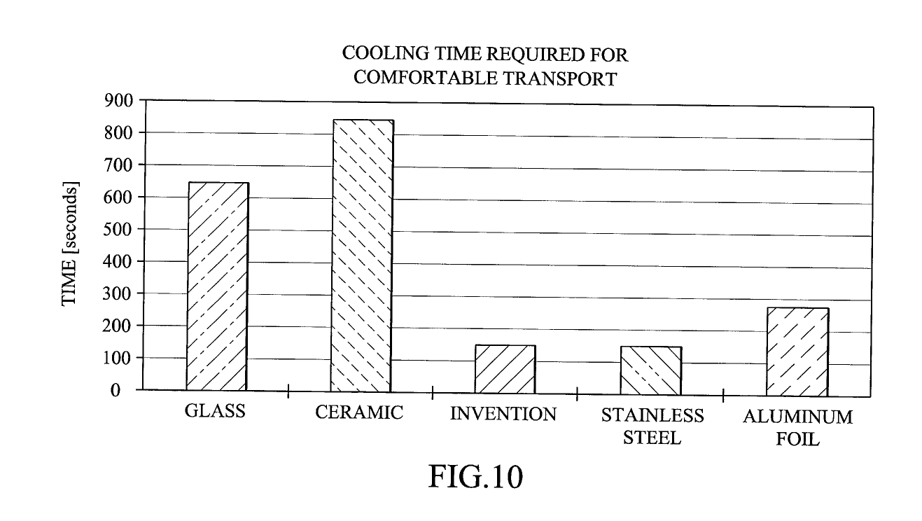

As shown in FIG. 8, the handles of the inventive pan were cooler than the handles (or flanges) of the other four pans after about 3 minutes following removal, and the handles of the inventive pan were much cooler than the handles of the other two dual-ovenable pans at all times after removal. As shown in FIG. 9, the maximum temperature permitting comfortable transport was highest for the inventive pan, and this temperature for the inventive pan was considerably higher than the corresponding temperatures for the other two dual-ovenable pans. As shown in FIG. 10, the cooling time required to reach comfortable transport temperature was least for the inventive pan, with the stainless steel pan being a close second, and with the inventive pan reaching that temperature considerably sooner than the other two dual-ovenable pans.

It will be understood that, while presently preferred embodiments of the invention have been illustrated and described, the invention is not limited thereto, but may be otherwise variously embodied within the scope of the following claims.

1. A nestable, dual-ovenable cooking pan which consists essentially of thermoformed plastic sheet material having a thickness in the range of from about 0.020 to about 0.050 inch and comprises
a horizontal bottom;
walls extending upwardly from the periphery of the bottom at an obtuse angle;
a continuous, horizontal, outwardly extending flange at the top of the walls; and
two integral handles in the flange at opposite ends of the pan, each handle having a gripping area comprising undulations which are formed in the sheet material having said thickness and which result in an effective thickness of the handle at least three times that thickness; whereby
the undulations contribute to the strength and rigidity of the pan,
the handles have a purchase and tactile feel similar to those of thicker handles of ceramic permanent cookware, and,
when the pan is moved from a hot conventional oven to an ambient atmosphere, the handles cool relatively quickly.

2. A pan according to claim 1 wherein the sheet material is resistant to temperatures of 400° F. and consists essentially of nucleated CPET whose crystallinity is in the range of 20 percent to 40 percent.

3. A pan according to claim 1 wherein the sheet material has a thickness in the range of from about 0.030 to about 0.045 inch.

4. A pan according to claim 1 which is disposable.

5. A pan according to claim 1 wherein the bottom of the pan is rectangular and the walls are joined with each other at four corners.

6. A pan according to claim 1 wherein the bottom of the pan is circular and the walls have a continuous frustoconical configuration.

7. A pan according to claim 1 wherein the maximum horizontal dimension of the pan is the distance between the outermost extremities of the handles.

8. A pan according to claim 1 wherein, when the pan is moved from a hot conventional oven to an ambient atmosphere, the handles cool more quickly to a temperature at which they can be comfortably picked up and transported without gloves than would handles of ceramic permanent cookware of equivalent size and shape under equivalent conditions.

9. A pan according to claim 1 wherein the undulations form alternating ridges and valleys, with the horizontal distances between adjacent ridges and between adjacent valleys being sufficiently short, and the vertical distances between the uppermost and lowermost surfaces of sheet material being sufficiently great, as to limit the area of contact between the sheet material and the fingers of a user picking up the pan by the handles.

10. A pan according to claim 9 wherein the distances between adjacent ridges and between adjacent valleys are less than 20 times the thickness of the sheet material and the distances between the uppermost and lowermost surfaces of sheet material are greater than 3 times the thickness of the sheet material.

11. A pan according to claim 9 wherein the undulations are uniform and form parallel ridges and valleys.

12. A pan according to claim 9 wherein the undulations are not uniform.

13. A pan according to claim 9 wherein the undulations are not parallel.

14. A pan according to claim 9 wherein the undulations form a decorative pattern.

15. A nestable cooking pan which consists essentially of thermoformed plastic sheet material having a thickness in the range of from about 0.020 to about 0.050 inch and comprises
a horizontal bottom;
walls extending upwardly from the periphery of the bottom at an obtuse angle;
a continuous, horizontal, outwardly extending flange at the top of the walls;
two integral handles in the flange at opposite ends of the pan;
the walls including a plurality of parallel horizontal strengthening ribs which extend around only a minor portion of the periphery of the walls.

16. A pan according to claim 15 wherein the bottom of the pan is rectangular and the horizontal strengthening ribs are located at the corners formed by adjacent walls.

17. A pan according to claim 15 wherein the bottom of the pan is circular and the horizontal strengthening ribs are located beneath the handles.

18. A disposable, nestable, dual-ovenable cooking pan which consists essentially of thermoformed plastic sheet material having a thickness in the range of from about 0.020 to about 0.050 inch, being resistant to temperatures of 400° F., and consisting essentially of nucleated CPET whose crystallinity is in the range of 20 percent to 40 percent, which pan comprises
a horizontal bottom;
walls extending upwardly from the periphery of the bottom at an obtuse angle and including a plurality of parallel horizontal strengthening ribs which extend around only a minor portion of the periphery of the walls;
a continuous, horizontal, outwardly extending flange at the top of the walls; and
two integral handles in the flange at opposite ends of the pan, each handle having a gripping area comprising undulations which are formed in the sheet material having said thickness and which result in an effective thickness of the handle at least three times that thickness; whereby
the undulations contribute to the strength and rigidity of the pan,
the handles have a purchase and tactile feel similar to those of thicker handles of ceramic permanent cookware, and,
when the pan is moved from a hot conventional oven to an ambient atmosphere, the handles cool more quickly to a temperature at which they can be comfortably picked up and transported without gloves than would handles of ceramic permanent cookware of equivalent size and shape under equivalent conditions.

19. A pan according to claim 18 wherein the undulations form alternating ridges and valleys, with the horizontal distances between adjacent ridges and between adjacent valleys being sufficiently short, and the vertical distances between the uppermost and lowermost surfaces of sheet material being sufficiently great, as to limit the area of contact between the sheet material and the fingers of a user picking up the pan by the handles.
